(19) United States
(12) Patent Application Publication
(10) Pub. No.: US 2011/0180360 A1
(43) Pub. Date: Jul. 28, 2011

(54) OVERPRESSURE AND BOTTOMING DETECTOR FOR A SHOCK-ABSORBER OR THE LIKE

(75) Inventors: Pascal Martin, Breuillet (FR); Dominique Ducos, Savigny Sur Orge (FR)

(73) Assignee: MESSIER-DOWTY SA, Velizy Villacoublay (FR)

(21) Appl. No.: 13/063,243

(22) PCT Filed: Sep. 1, 2009
(86) PCT No.: PCT/FR2009/001049

§ 371 Date: Apr. 12, 2011

(30) Foreign Application Priority Data
Sep. 12, 2008 (FR) 0805010

(51) Int. Cl. F16F 9/32

(52) U.S. Cl. 188/266.8

(57) ABSTRACT

The invention relates to an overpressure and bottoming detector for a shock-absorber or the like, the detector including a hollow body inside which a piston slides sealingly and that is designed to be subjected to a pressure via an inlet of the body that is in communication with an enclosure in which said pressure exists, the piston being retained in position against the pressure by threshold retaining means adapted to release the piston when the pressure reaches or exceeds said threshold in such a manner that the piston is pushed under the effect of the pressure towards an indication position, and wherein the piston is secured to a pin that projects from the inlet of the body so as to be capable of being pushed against the threshold retaining means.

The invention relates to an overpressure and bottoming detector, in particular to an aircraft landing gear shock-absorber.

### TECHNOLOGICAL BACKGROUND

It can happen that aircraft are subjected to hard landings, i.e. landings at a vertical speed that is greater than the speed used for designing the landing gear. The shock-absorbers of the landing gear may then be subjected to overpressure during which the pressure inside the shock-absorber becomes greater than the design pressure of the shock-absorber, or it may even be subjected to bottoming during which the two telescopic portions of the shock-absorber come into internal abutment. Circumstances other than a hard landing can lead to overpressure or bottoming. In particular, such events can occur if the aircraft is overloaded or if the shock-absorber is poorly conditioned (inappropriate oil or inflation level).

It is important to detect that said events have occurred since, in the long term, they can weaken or even damage the shock-absorber.

Overpressure detectors are known that comprise a hollow body defining a chamber that is put into communication with the inside of a shock-absorber and that is closed by a piston sliding sealingly, the piston being retained in position against the pressure that exists inside the shock-absorber by threshold retaining means. When the pressure in the shock-absorber increases and exceeds the threshold of the retaining means, said retaining means release the piston, which is pushed under the effect of the pressure towards an overpressure indication position.

The piston may have an indicator that becomes visible when the piston is pushed, or that then actuates a sensor that sends an electrical signal indicating that the overpressure threshold has been exceeded.

Bottoming is generally detected by a micro-contact located either inside the shock-absorber, or outside said shock-absorber, for actuation when both telescopic portions move towards each other to the point at which bottoming looks if not unavoidable, then is at least very close.

### OBJECT OF THE INVENTION

The invention provides a single detector that responds in the same way in the event of overpressure or in the event of bottoming.

### BRIEF DESCRIPTION OF THE INVENTION

With a view to achieving this object, the invention provides a detector including a hollow body inside which a piston slides sealingly and that is designed to be subjected to a pressure via an inlet of the body that is in communication with an enclosure inside which said pressure exists, the piston being retained in position against the pressure by threshold retaining means adapted to release the piston when the pressure reaches or exceeds said threshold in such a manner that the piston is pushed under the effect of the pressure towards an indication position, and wherein the piston is secured to a pin that projects from the inlet of the body so as to be capable of being pushed against the threshold retaining means.

Thus, the piston can be actuated by the pressure that reaches or exceeds the pressure threshold, but it can also be actuated by pushing on the pin with a force that is sufficient to overcome the retaining means. It then suffices to place the detector of the invention appropriately on the shock-absorber, in such a manner that the pin can be pushed back by one of the portions of the shock-absorber sliding in the other, when that portion comes close to bottoming, or when bottoming occurs.

Thus, by means of a single detector, it becomes possible not only to detect overpressure, but also bottoming.

### BRIEF DESCRIPTION OF THE FIGURES

The invention can be better understood in the light of the following description of the accompanying drawing, illustrating a particular embodiment of the invention in non-limiting manner, and in which:

FIG. 1 is a longitudinal section view of an aircraft shock-absorber fitted with a detector of the invention;

FIG. 2 is an enlarged section view of the detector of FIG. 1, when it has not been actuated; and

FIG. 3 is a section view analogous to that of FIG. 2, showing the actuated detector.

### DETAILED DESCRIPTION OF THE FIGURES

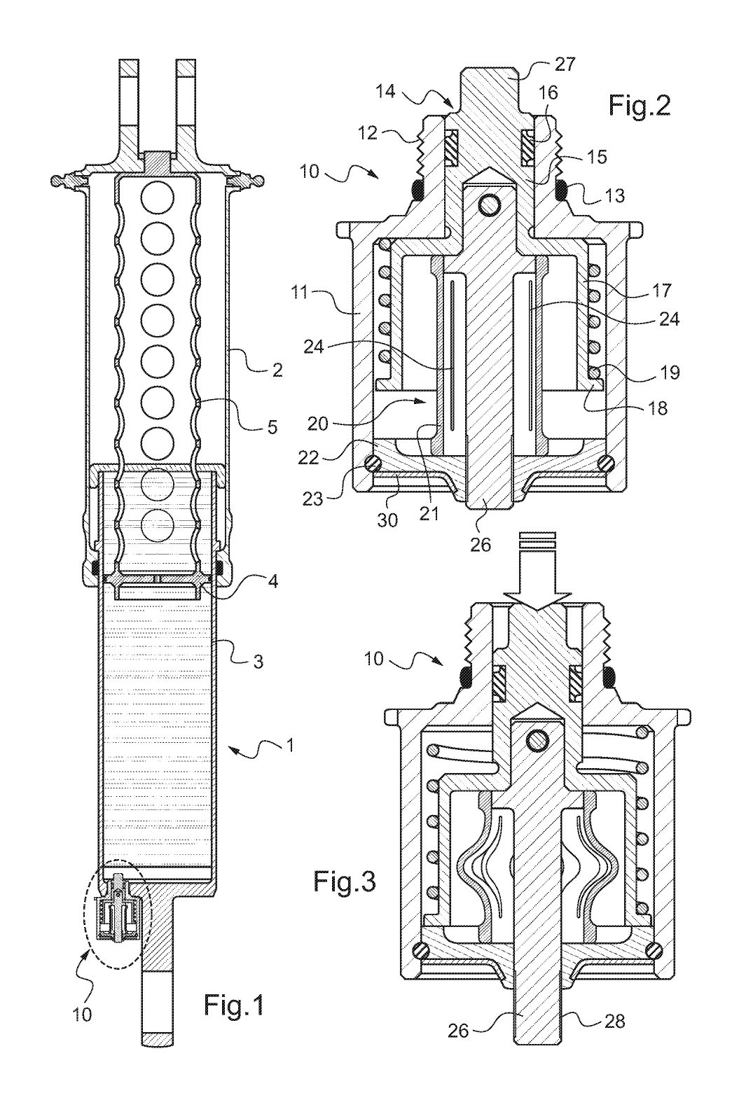

The invention is described herein with reference to an aircraft shock-absorber, which shock-absorber 1 can be seen in FIG. 1. In the figure, it is an independent shock-absorber, hinged between an undercarriage strut that is attached directly to the aircraft, and a rocker arm that is hinged to the strut and that carries the wheel(s) of the undercarriage.

The shock-absorber 1 comprises a cylinder 2 in which a rod 3 is telescopically mounted to slide sealingly. A diaphragm 4 is carried by a perforated tube 5, referred to as a column, fastened to the end of the cylinder 2, and it separates an “oil” first chamber extending inside the rod 3 as far as the diaphragm 4, from a second chamber extending inside the cylinder 2 as far as the diaphragm 4, said second chamber being referred to as the “air” chamber since it is mainly filled with gas under pressure. A third chamber, referred to as the “annular” chamber, extends between the outside face of the rod 3 and the inside face of the cylinder 2. This is all well known and is stated solely for the purpose of illustration. A detector 10 of the invention is placed on the shock-absorber 1 at the base of the rod 3.

The detector 10 is described below with reference to FIG. 2. The detector 10 includes a generally cylindrical hollow body 11 defining a cavity. The body 11 presents a threaded neck 12 provided with a sealing gasket 13 in order to screw-fasten said gasket in leaktight manner inside a complementary tapping in the base of the rod 3 of the shock-absorber 1. The inside of the neck 12 defines a guide bearing for guiding a piston 14. More precisely, the piston 14 includes a guide rod 15 that is inserted into the neck 12 and that has a sealing gasket 16. The guide rod 15 is followed by a bell 17 that opens out into the cavity of the body 11 and ends in a rim 18 against which a helical spring 19 presses, which spring extends between the end of the cavity in the body 11 and the rim 18.

The detector includes retaining means 20 for retaining the piston 14 in abutment against the end of the cavity of the body 11. The retaining means 20 include a rated column 21 that extends between the end of the bell 17 and a lid 22 that closes the body 11 and that is held on said body by a ring 23.

The rated column 21 presents a generally circular shape with its main portion deliberately weakened by making longitudinal slots 24 that serve to define very accurately a critical force threshold from which the rated column 21 buckles under the effect of a compression force. Finally, the detector 10 includes means for indicating the position of the piston 14, in the form of an indicator 26 that is secured to the piston 14 and that extends through the lid 22. It should be observed that, in the invention, the piston 14 is provided with a pin 27 that projects from the neck 12 and that, when the detector 10 is in place on the rod 3 of the shock-absorber 1, projects into the rod 3.

The operation of the detector is as follows: The piston 14 is capable of being pushed into the body 11 when the force to which the piston 14 is subjected to exceeds the critical buckling force of the rated column 21. Such a force may occur if the pressure in the rod 3 of the shock-absorber 1 exceeds a value such that, when multiplied by the section of the guide rod 15, the resulting force reaches or exceeds the critical buckling force of the rated column 21, as happens during a period of overpressure inside the shock-absorber. Thus, the critical buckling force of the rated column 21, divided by the section of the guide rod 15, defines an overpressure threshold beyond which the detector 10 is actuated.

In the event of the shock-absorber being compressed to such an extent that the diaphragm 4 touches and then pushes against the finger 27 of the detector 10, such a force may also be applied if the force exerted by the diaphragm 4 on the finger 27 reaches or exceeds the critical buckling force of the rated column 21, which occurs when the shock-absorber is close to bottoming. Thus, the critical buckling force of the rated column 21 directly defines the bottoming threshold beyond which the detector 10 is actuated.

As shown in FIG. 3, in which the rated column 21 is shown buckled, buckling the rated column 21 releases the piston 14 so that, under thrust from the spring 19, it moves to an indication position as shown in the figure, in which position the indicator 26 then clearly projects beyond the lid 22. In this embodiment, its end is covered with a colored coating 28 in such a manner that its projecting portion is particularly visible.

In a particular aspect of the invention, the detector 10 is made tamperproof so that it cannot be reset by replacing the buckled rated column 21 with a new column 21. To this end, the lid 22 is covered with a crimped metal sheet 30 that covers the ring 23, thus preventing any removal of the lid and thus any access to the rated column 21. It is therefore necessary to replace the detector with a new detector, which has not been actuated, and that requires removal of the shock-absorber since said shock-absorber needs to be deflated and drained of its oil beforehand.

It should be observed that the overpressure actuation threshold and the bottoming actuation threshold both depend on the critical buckling force of the rated column 21, but that the overpressure actuation threshold also depends on the section of the guide rod 15. By acting on these parameters, it is possible to design a detector having an overpressure threshold and a bottoming threshold that can be chosen in arbitrary manner.

Naturally, the invention is not limited to the above description, but on the contrary it encompasses any variant coming within the ambit defined by the claims.

In particular, although it is stated that actuation of the detector is manifested by a visible indicator of the detector, it is naturally possible to make use of the movement of the piston to actuate an electric contact for sending an event detection electrical signal, instead of, or better in parallel with, using a visible indicator.

Although it is indicated above that the threshold retaining means include a rated column that buckles under a determined critical buckling force, any other threshold retaining means could be used, such as an oil chamber that is closed by a rated valve that opens when the pressure inside the chamber reaches a critical threshold.

1. An overpressure and bottoming detector for a shock-absorber or the like, the detector including a hollow body inside which a piston slides sealingly and that is designed to be subjected to a pressure via an inlet of the body that is in communication with an enclosure inside which said pressure exists, the piston being retained in position against the pressure by threshold retaining means adapted to release the piston when the pressure reaches or exceeds said threshold in such a manner that the piston is pushed under the effect of the pressure towards an indication position, and wherein the piston is secured to a pin that projects from the inlet of the body so as to be capable of being pushed against the threshold retaining means.

2. A detector according to claim 1, wherein the threshold retaining means comprise a rated column designed to buckle at a determined critical buckling force.

3. A detector according to claim 1, wherein the piston is associated with a visual indicator that projects from the body of the detector when the piston has been pushed.

4. A detector according to claim 1, wherein the retaining means and the piston are enclosed inside a portion of the body that is tamperproof in that replacing the retaining means is impossible.

5. A detector according to claim 4, wherein the portion of the body receiving the piston and the retaining means is closed by a lid retained by a retainer ring, the ring itself being covered by a crimped metal sheet.
